(19) United States
(12) Patent Application Publication
(10) Pub. No.: US 2017/0259171 A1
(43) Pub. Date: Sep. 14, 2017

(54) Method for Creating, Maintaining, and Participating in an On-Line Community for Education, Smart Cities, eGovernment and Living Sustainable Lifestyles

(71) Applicant: Ryan Eric Johnsen Kelmar, Santa Barbara, CA (US)

(72) Inventor: Ryan Eric Johnsen Kelmar, Santa Barbara, CA (US)

(21) Appl. No.: 15/069,745

(22) Filed: Mar. 14, 2016

(51) Int. Cl. A63F 13/30; A63F 13/55; A63F 13/79; A63F 13/87

(52) U.S. Cl. CPC A63F 13/30; A63F 13/87; A63F 13/55; A63F 13/79

(57) ABSTRACT

The present invention relates to methods for creating, maintaining, and participating in an on-line community for education, behavior modification, Smart Cities, eGovernment and sustainable lifestyles. More particularly, this invention is for an on-line open source methodology for multiple participants, taking place in a shared virtual space to enable health education and behavior modification; smart city development and government participation, and living sustainable lifestyles. An important element of this invention is the use of guests, which is a specific player task that represents real world problems, such as those published by government agencies, like the Smart Cities Council.

### CROSS REFERENCE TO RELATED APPLICATIONS

This application is related to and claims priority from U.S. Provisional Patent Application: ‘Quests for Sustainability, the Ultimate Game for Smart Cities and Wellness’, 62/133,434 filed on Mar. 15, 2015. Other patent applications filed by Cheryl May Kelmar, including 60/474,946, filed Jul. 24, 2003; Ser. No. 10/884,369; 60/474,942; 60/592,892; 60/474,939; 60/474,938; 60/474,945; 60/474,947; and 60/474,943 are incorporated by reference in their entirety.

### BACKGROUND OF THE PRESENT INVENTION

Field of Invention

The present invention relates to methods for creating, maintaining, and participating in an on-line community for education, behavior modification, Smart Cities, eGovernment and sustainable lifestyles. More particularly, this invention is for an on-line open source methodology for multiple participants, taking place in a shared virtual space to enable health education and behavior modification; smart city development and government participation, and living sustainable lifestyles. An important element of this invention is the use of guests, which is a specific player task that represents real world problems, such as those published by government agencies, like the Smart Cities Council.

Description of the Related Art

The world is experiencing a period of extreme urbanization. In China alone, more than 250 million rural inhabitants will move to urban areas over the next 15 years. This will require building new infrastructure to accommodate nearly the equivalent of the current population of the United States in a matter of a few decades. Cities in the 21st century will account for nearly 90% of global population growth, 80% of wealth creation, and 60% of total energy consumption. It is a global imperative to develop systems that improve the livability of cities while dramatically reducing resource consumption.

Numerous methods and strategies have been developed to address advances in technology and innovation to cultivate cities which are smarter, more resilient, and sustainable; and to manage population health processes and wellness strategies for proactive collaboration and care planning. Our mission is to support this growing worldwide movement towards living sustainable lifestyles and the creation of Smart Cities and Smart Citizen.

The Internet of Things is fast emerging as a key element in a growing number of smart city solutions, illustrated by the use of sensors, cameras, GPS mapping and analytics. Policymakers and public leaders are increasingly looking to information and communications technology solutions to effectively provide public services like education, healthcare, safety, transportation, and utilities. Around the world we see positive examples of cities and citizens joining forces, such as: bicycle sharing based on real-time demand, monitoring of available parking spaces to reduce traffic congestions, behavior based waste management fees, city councils actively using community forums as part of decision making, citizens building apps to simplify access to city service hotlines, small particle sensors owned by residents to influence programs to improve air quality, and so forth.

However, although effective and appropriate in some situations, very often comprehensive approaches are extremely expensive and may be less than effective, because they have not been sufficiently adapted or effective due to technical limitations, educational techniques and widespread use and acceptance.

The present invention is a method for creating, maintaining, and participating in an on-line community for education, behavior modification, smart cities, eGovernment, smart citizens and living sustainable lifestyles using gamification techniques, which is effective, inexpensive to implement, and highly adaptable to a wide variety of situations.

Additional objects and advantages of the present invention will be set forth in the description that follows, and in part will be obvious from the description, or may be learned by practice of the present invention. The objects and advantages of the present invention may be realized and obtained by means of the instrumentalities and combinations particularly pointed out in the appended claims.

### BRIEF SUMMARY OF THE PRESENT INVENTION

The method of the present invention is effected by a first preferred embodiment as provided herein for creating, maintaining, and participating in an on-line community for education, behavior modification, smart cities, eGovernment, smart citizens and living sustainable lifestyles using quests, comprising multiple-component strategies pertaining to individuals, families, peer groups, and selected environments and providing access methods to participants to engage in interactive communications within an online community. Software scripts are translated to electronic instructions for interactive software with an adaptable and modular code base consisting of both client and server components, for interactive use by participants in situational environments.

### BRIEF DESCRIPTION OF THE DRAWINGS

The accompanying drawings, which are incorporated in and constitute a part of the specification, illustrates a preferred embodiment of the present invention and, together with a general description given above and the detailed description of the preferred embodiment given below, serve to explain the principles of the present invention.

FIG. 1 illustrates a first preferred embodiment of the present invention comprising an online community with player avatars, communication, such as chat, player assets and rewards and visual locations.

FIG. 2 is a flow diagram of a first preferred embodiment of the method of the present invention that enables creating, maintaining, and participating in an on-line community for education, smart cities, government participation and living a sustainable life.

FIG. 3 is a flow diagram of a second preferred embodiment of the methodology, according to the method of the present invention, and enabled by the first preferred embodiment of the present invention of FIG. 1.

### DETAILED DESCRIPTION OF THE PRESENT INVENTION

Reference will now be made in detail to the present preferred embodiments of the present invention as illustrated in the accompanying drawings.

Upon entry, players' health indicators are determined from Healthy People 2010. Then, players choose game communities as individuals, or a group. Each community reflects a theme from an actual place in the world. The more issues a community has, such as a poor and/or indigenous, the more points that are available. Communities compete against each other within game classifications, based upon community size.

As players move toward higher levels, they shall be presented with quests, questions and topical mobile applications to gain knowledge about health, gardening, nutrition, exercise, the building of smart cities, land and water use, tourism, trip planning, public transportation, etc. An open architecture will be used in order to use a variety of software and platforms from companies, individuals and the government to provide a comprehensive and dynamic selection of products developed for sustainability and smart cities. A database back-end provides for storage, tracking and use of big data.

To climb to new levels, each player must successfully complete their quests for their entire community to move to a new level. As communities rise to new levels; new areas, tools and rewards are unlocked, which include a park, a bull dozer for construction and opportunities to purchase in-game merchandise.

Players can participate in quests as a single individual or part of a group. Players compete against each other within communities. Players can use the power of Facebook and Twitter to bring others to their community.

As players gain knowledge, they shall be rewarded with in-game merchandise for their character, as well as in-game currency they can use to purchase real world resources from the virtual mall and other game rewards. Rewards include in-game currency.

Additional points are given for real world solutions with the ability to post videos, buy in-game merchandise, and real world prizes from sponsors. Players shall gain points thru purchases from poor and/or indigenous communities within the Virtual Mall.

The locations shall include an education center, café, eco city building, community center, entrepreneur center, health center, theater and virtual mall. The Educational Center will be used for workshops/webinars, concerts, lectures, film screenings, healing sessions, cooking classes, farming-related activities, etc. The Education Center shall provide a full directory of resources for sustainability, including a full library on documentary films, tutorials and other types of educational videos. Players will be allowed to post their own educational videos as they rise to higher levels.

In the Health Center, a Café, Garden, Cooking School and Gym shall assist people in their commitment to take responsibility for their own health. Health profiles are collected within the Health Center. In the location for Eco City Building, a research lab exists to allow architects, designers and entrepreneurs to prototype their concepts in a 3D virtual space using simulated real world resources. Research in urban organic gardening practices, sustainable textiles, green building techniques, alternative energy sources and implementation, emotional intelligence and spirituality shall be promoted. A Community Center shall provide messaging boards, conferencing and other methods for people to connect with each other.

Access to mobile applications and mini-games shall be scatter throughout each community through portals designed with different topics and venues. Data collection will continually be done of in-game parameters and rewards.

### DESCRIPTION OF THE DIAGRAMS AND INVENTION

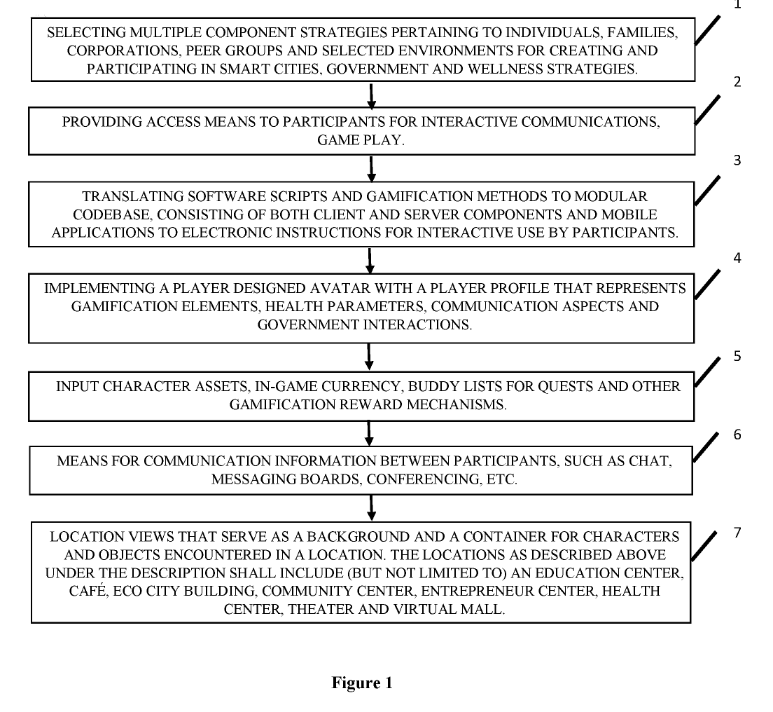

FIG. 1 illustrates a first preferred embodiment of the present invention, having a computer network optionally comprising a plurality of participant computer systems together for electronic messaging and data access.

The community as defined in 1 provides means for enabling a first preferred embodiment of the method of the present invention for creating, maintaining, and enabling participation in an on-line community by a participant for education, building smart cities, participating in government and living a sustainable life. The method of the present invention, in the first preferred method provides access means to participants for interactive communication, game play and virtual reality scenarios 2.

Software scripts and gamification methods for a modular codebase consist of both client and server components, and mobile applications, to electronic instructions 3 for interactive use by participants.

The participant database module is used to maintain accounts, passwords and access levels of the community. Participants use embedded questionnaires as they enter the online community to provide their health indicators, social parameters and the like. Such information determines a participant's profile 4.

These health indicators and social parameters might include substance abuse, physical activity, overweight and obesity, tobacco use, responsible sexual behavior, injury and violence, mental health, environmental quality, and the like. The information may affect the score, status, non-participant character interaction, quests, levels, variables and other interactions.

According to the preferred method, participants input character assets create participant ‘profiles’ to the online community scripts of the software script module and may implement a buddy list composed of other participant's screen names. The buddy list may be implemented according to certain prior art techniques, known in the art for enabling a participant to access and select from a selected group of email addresses.

A participant profile may include a picture of the character in a magnified view showing the character's current wardrobe, which includes apparel, jewelry, accessories and body modifications. The character's screen name, the character's level, the number of items in the character's inventory, the character's health and knowledge profile, and the character's “personal”, a text description similar to the self-descriptions in personal ads, composed of adjectives earned by gaining levels, may be included. Other information obtained a Buddy List 5 is another example of such information.

The character profile is used to determine level, high-risk situation, locations the participant can access, and the like. The level of a participant reflects their health status and play variables, and is a function of play. As players move toward higher levels, they shall be presented with quests, questions and topical mobile applications to gain knowledge about health, gardening, nutrition, exercise, the building of smart cities, land and water use, tourism, trip planning, public transportation, etc.

Players can participate in quests as a single individual or part of a group. Players compete against each other within communities. Players can use the power of Facebook and Twitter to bring others to their community. As players gain knowledge, they shall be rewarded with in-game merchandise for their character, as well as in-game currency they can use to purchase real world resources from the virtual mall and other game rewards. Rewards include in-game currency 5. Additional points may be provided for real world solutions with the ability to post videos, buy in-game merchandise, and real world prizes from sponsors.

The methodology of the present invention optionally may comprise and implement multiple-component strategies across one or more social systems involving individuals, families, peer groups, and diverse environments. Chat and online community interactive interaction support and enrich one another 6 and other suitable behavior modification support systems and techniques known in the art.

Location views are created to serve as a background and a container for characters and objects encountered in a location 7, and various activities. Preferably, a Map screen provides global navigation to the locations. Clicking the name or image of a location takes the participant to the location. In the preferred methodology, the online community world has a plurality of locations.

Examples of locations include an education center, café, eco city building, community center, entrepreneur center, health center, theater and virtual mall. Location views serve as background and container for interactive characters and objects that are encountered in the locations, such view may include embedded communications such as sponsored ads, video and audio can be embedded throughout all the locations if desired.

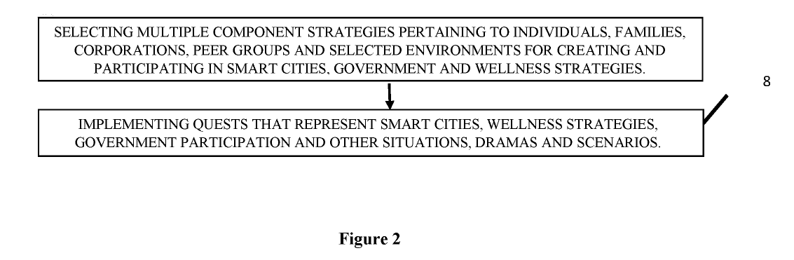

In accordance with still certain alternate preferred embodiments of the present invention, the method of the present invention provides a method, and the preferred embodiment of the present invention of FIG. 2 provides the means for creating and supporting a participatory on-line community for education, creating smart cities, participating in government and wellness behavioral modification strategies.

The ability to complete quests allows the participants access to new locations and levels, and to move to new places and activities within locations. To climb to new levels, each player must successfully complete their quests 8 or their entire community to move to a new level. As communities rise to new levels; new areas, tools and rewards are unlocked, which include a park, a bull dozer for construction and opportunities to purchase in-game merchandise.

An open architecture will be used in order to use a variety of software and platforms from companies, individuals and the government to provide a comprehensive and dynamic selection of products developed for sustainability and smart cities 9.

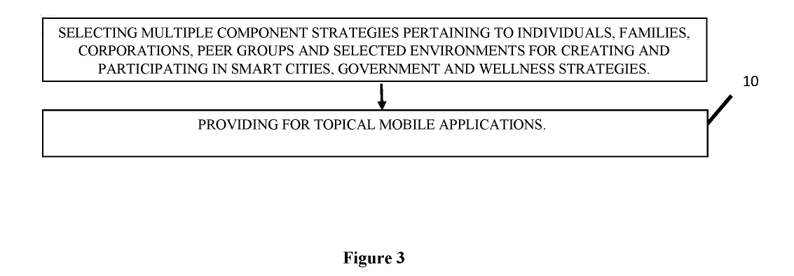

In accordance with still certain alternate preferred embodiments of the present invention, the method of the present invention provides a method, and the preferred embodiment of the present invention of FIG. 3 for topical mobile applications 10. Examples of mobile applications include Smoke Screen, Banana Jones, Power Up, Good Decision Driving Game, Concentration Game and others.

What is claimed is:

1. A method for creating, maintaining, and participating in an on-line community for education, behavior modification, smart cities, eGovernment and living sustainable lifestyles, comprising:
providing a participant system;
providing the software to generate;
a. a player avatar, controlled by the participant, with player profiles;
b. interactive and visual locations;
c. chat functionality;
d. reward mechanisms;
e. a database to collect all relevant information.
providing a client and a server, where the server hosts the software;

2. The method of claim 1, further including an open architecture to accommodate the integration of software for sustainability, smart cities, government participation and wellness strategies, comprising:
providing the software to generate;
a. interactive real-life situations, dramas, scenarios and quests;
b. mechanisms for building smart cities

3. The method of claim 1, further including means for communicating information between participants, comprising:
a. separate topical mobile applications.
